(19) United States
(12) Patent Application Publication
(10) Pub. No.: US 2009/0237474 A1
(43) Pub. Date: Sep. 24, 2009

(54) LIQUID CONTAINER AND DIFFERENTIAL PRESSURE REGULATING VALVE

(76) Inventors: Taku Ishizawa, Shiojiri-shi (JP); Tadahiro Mizutani, Shiojiri-shi (JP)

Correspondence Address: STROOCK & STROOCK & LAVAN LLP, 180 MAIDEN LANE, NEW YORK, NY, 10038, US

(21) Appl. No.: 12/407,028

(22) Filed: Mar. 19, 2009

(30) Foreign Application Priority Data
Mar. 21, 2008 (JP) 2008-073272

(51) Int. Cl. B41J 2/175; F16K 31/44

(52) U.S. Cl. 347/86; 251/227

(57) ABSTRACT

Provided is a differential pressure regulating valve having a first chamber, a second chamber, a communication flow path, and a movable membrane. The first chamber has a first inflow port for receiving the fluid flowed into the differential pressure regulating valve, and a first outflow port. The second chamber has a second inflow port and a second outflow port for transmitting the fluid. The communication flow path links the first outflow port and the second inflow port. The movable membrane is provided between the first chamber and the second chamber. Also, the movable membrane is able to open and close the first outflow port by deforming according to the difference (differential pressure) between the first pressure of the first chamber and the second pressure of the second chamber.

### CROSS-REFERENCE TO RELATED APPLICATIONS

The present application claims the priority based on Japanese Patent Application No. 2008-73272 filed on Mar. 21, 2008, the disclosure of which is hereby incorporated by reference in its entirety.

### BACKGROUND

1. Technical Field

The present invention relates to a liquid container and a differential pressure regulating valve, and particularly to a liquid container which can be installed in a liquid jetting device and the differential pressure regulating valve used for that liquid container.

2. Description of the Related Art

With an ink tank that supplies ink to an inkjet printer, technology is known that keeps the stored ink at negative pressure. For example, as means for generating negative pressure, an ink tank having a valve constitution using a membrane valve and a spring is known.

Also, various technologies that use valves are known relating to ink tanks that supply ink to inkjet printers.

### SUMMARY

However, there is the possibility of various problems relating to the valve. Examples of problems include the possibility of a large volume of ink not being consumed and remaining inside the valve, and the possibility of the differential pressure control becoming unstable. This kind of problem is not limited to the ink tanks for inkjet printers, but are also problems common to liquid containers that can be installed in a liquid jetting device.

The advantage of a number of modes of the invention is the provision of technology that decreases the possibility of problems relating to valves with liquid containers installed in a liquid jetting device.

The present invention can be reduced as the following aspects and modes for addressing at least part of the problems described above.

As a first mode, a differential pressure regulating valve is provided. The differential pressure regulating valve is equipped with a first chamber, a second chamber, a communication flow path, and a movable membrane. The first chamber has a first inflow port and a first outflow port. The fluid introduced into the differential pressure regulating valve flows into the first chamber through the first inflow port. The second chamber has a second inflow port and a second outflow port through which the fluid flows out from the second chamber. The communication flow path links the first outflow port and the second inflow port. The movable membrane is provided between the first chamber and the second chamber. The movable membrane can open and close the first outflow port by deforming according to a difference (differential pressure) between a first pressure in the first chamber and a second pressure in the second chamber.

With this constitution, the fluid path goes through the serially connected first chamber and second chamber via the communication flow path, so it is possible to reduce the volume of fluid that remains in the first chamber and the second chamber.

The present invention can be realized with various modes. It is possible to realize the present invention, for example, as a membrane valve in a liquid container that can be installed in a liquid jetting device. The liquid container has a liquid storage chamber for storing liquid, a liquid supply port for supplying the liquid to the liquid jetting device, a first flow path linked to the liquid storage chamber, and a second flow path linked to the liquid supply port. The membrane valve is interposed between the first flow path and the second flow path.

These and other objects, features, aspects, and advantages of the present invention will become more apparent from the following detailed description of the preferred embodiments with the accompanying drawings.

### BRIEF DESCRIPTION OF THE DRAWINGS

FIG. 1 is an exploded perspective view of an ink cartridge as the first embodiment of the invention.

FIG. 2 is a drawing showing a state with the ink cartridge attached to a carriage.

FIG. 3 is a drawing conceptually showing the path that reaches from the air opening hole to the liquid supply section.

FIGS. 4 (A)-4 (B) are first drawings for describing the constitution of the valve section of the first embodiment.

FIGS. 5 (A)-5 (B) are first drawings showing the constitution of the membrane valve.

FIGS. 6 (A)-6 (B) are second drawings showing the constitution of the membrane valve.

FIG. 7 is a second drawing for describing the constitution of the valve section of the first embodiment.

FIG. 8 is a third drawing for describing the constitution of the valve section of the first embodiment.

FIG. 9 is a drawing for describing the constitution of the valve section 180 of the second embodiment.

FIG. 10 is a drawing for describing the constitution of the valve section 180 of the third embodiment.

FIG. 11 is an explanatory drawing showing the constitution of the valve section 180K of the fourth embodiment.

FIG. 12 is an explanatory drawing showing the open valve state of the valve section 180K.

FIG. 13 is an explanatory drawing showing the state with the ink residual volume reduced.

FIG. 14 is an explanatory drawing showing the constitution of the valve section 180Ka of the fifth embodiment.

FIG. 15 is an explanatory drawing showing the constitution of the valve section 180Kb of the sixth embodiment.

FIG. 16 is an explanatory drawing showing the constitution of the valve section 180Kc of the seventh embodiment.

FIG. 17 is an explanatory drawing showing the constitution of the valve section 180Kd of the eighth embodiment.

### DESCRIPTION OF THE PREFERRED EMBODIMENTS

Following, embodiments of the invention will be will described. With the description of the embodiments, high/low and up/down use the direction of gravitational force as the standard, and the top surface, bottom surface, front, back, left, and right use the state with the liquid container placed in the liquid consumption device as the standard. Here, when the gravitational force direction bottom side is the first surface, the surface facing opposite the first surface (the gravitational force direction top side surface) is the second surface, the wide surfaces facing opposite each other that cross the first and second surfaces are the third and fourth surfaces, and the narrow surfaces that face opposite each other that cross the first through fourth surfaces are the fifth and sixth surfaces, with this embodiment, the first surface is the bottom surface, the second surface is the top surface, the third surfaces is the first side surface, the fourth surface is the second side surface, the fifth surface is the front surface, and the sixth surface is the back surface.

Also, with the second through eighth embodiments, the description will focus on a part that is different from any of the previously described embodiments. With these embodiments, for elements given the same shared code number as elements described previously, the constitution, materials, modified embodiments and the like common to the elements described previously are applied.

### A. First Embodiment

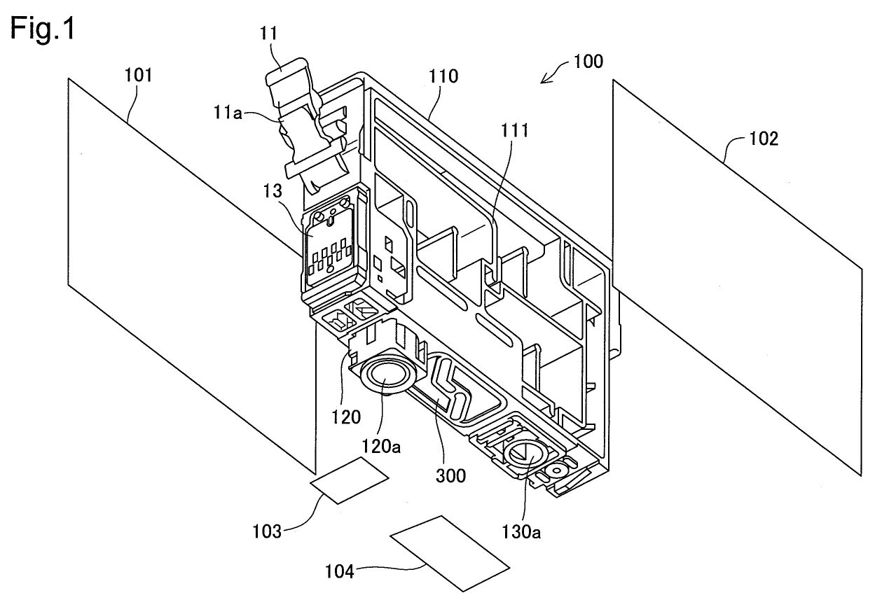

FIG. 1 is an exploded perspective view of an ink cartridge as the first embodiment of the invention. The ink cartridge 100 is equipped with a main body 110, a first side film 101, a second side film 102, a first bottom film 103, and a second bottom film 104.

Provided on the bottom surface of the main body 110 is an ink supply section 120 which has a supply port 120a for supplying ink to an inkjet printer. At the bottom surface of the main body 110 is opened an air opening hole 130a for introducing the atmosphere inside the ink cartridge 100. A spring seat member 300 is fit on the bottom surface of the main body 110. An engaging lever 11 is provided on the front surface of the main body 110. A projection 11a is formed on the engaging lever 11. A circuit board 13 is provided on the lower side of the engaging lever 11 of the front of the ink cartridge 100. A plurality of electrode terminals are formed on the circuit board 13, and when installing in a liquid jetting device, the electrical connection of these electrode terminals to the inkjet printer is made via the electrode terminals on the device side. Ribs 111 having various shapes are formed on both side surfaces of the main body 110. The side films 101 and 102 are adhered on the main body 110 so as to cover the entirety of both side surfaces of the main body 110. The side films 101 and 102 are adhered closely so that gaps do not occur between the end surface of the ribs 111 and the side films 101 and 102. With these ribs 111 and side films 101 and 102, on the interior of the ink cartridge 100, a plurality of compartments, for example the ink storage chamber, the buffer chamber, or the ink flow path described later are formed as compartments. Similarly, the first bottom film 103 is adhered on the front end part of the bottom surface of the ink cartridge 100, and the second bottom film 103 is adhered on the bottom surface of the spring seat member 300, and the ink flow path is formed as a compartment together with the adhered members.

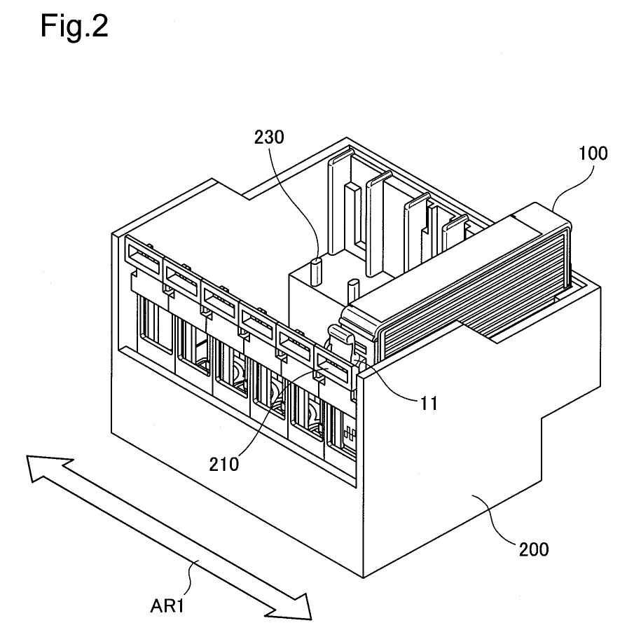

FIG. 2 is a drawing showing a state with the ink cartridge attached to a carriage. The air opening hole 130a has a depth and diameter so as to fit with a margin so that the projections 230 formed on the cartridge 200 of the inkjet printer have a specified gap. The ink cartridge 100 is fixed to the carriage 200 by having the projection 11a of the engaging lever 11 engage with the concave portion 210 formed in the carriage 200 when installed in the carriage 200. During printing with the inkjet printer, the carriage 200 becomes one unit with the printing head (not illustrated), and moves back and forth in the paper width direction of the printing medium (main scan direction). The main scan direction is as shown by arrow AR1 in FIG. 2.

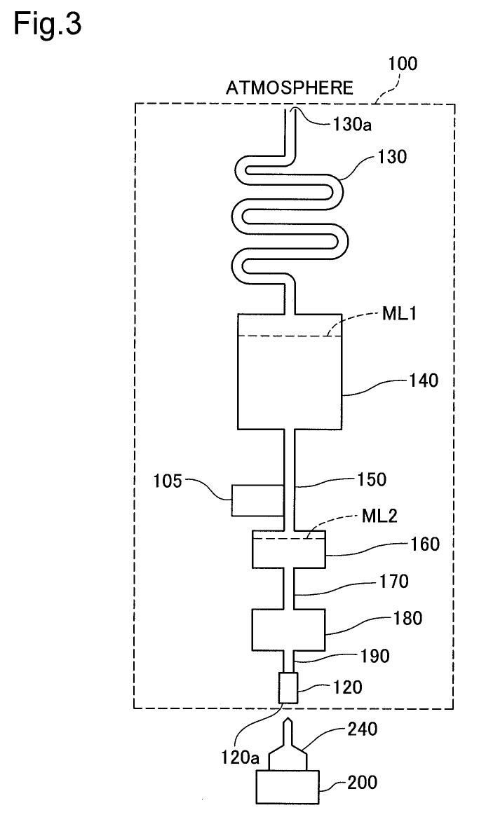

FIG. 3 is a drawing conceptually showing the path that reaches from the air opening hole to the liquid supply section. The ink path will be described which is formed compartmentalized by the main body 110, the spring seat member 300, and the films 101 to 104 described above. This ink path contains in sequence from upstream a serpentine path 130, an ink storage chamber 140, an intermediate flow path 150, a buffer chamber 160, a valve upstream path 170, a valve section 180, a valve downstream path 190, and an ink supply section 120. The serpentine path 130 has the upstream end linked to the air opening hole 130a, and the downstream end linked to the upstream side of the ink storage chamber 140 via the gas-liquid separation membrane (not illustrated). The serpentine path 130 is formed long and thin and in serpentine fashion so as to make the distance from the air opening hole 130a to the ink storage chamber 140 longer. By doing this, it is possible to suppress evaporation of the moisture in the ink within the ink storage chamber 140. The gas-liquid separation membrane is constituted as a component that allows transmission of gases while not allowing transmission of liquid.

The downstream side of the ink storage chamber 140 is linked to the upstream end of the intermediate flow path 150, and the downstream end of the intermediate flow path 150 is linked to the upstream side of the buffer chamber 160. The downstream side of the buffer chamber 160 is linked to the upstream end of the valve upstream path 170, and the downstream end of the valve upstream path 170 is linked to the upstream side of the valve section 180. The downstream side of the valve section 180 is linked to the upstream end of the valve downstream path 190, and the downstream end of the valve downstream path 190 is linked to the ink supply section 120. When the ink cartridge 100 is installed in the inkjet printer, an ink supply needle 240 equipped on the carriage 200 is inserted in the supply port 120a of the ink supply section 120. The ink inside the ink cartridge 100 is supplied via the ink supply needle 240 for printing by the inkjet printer.

A sensing section 105 is arranged in contact with the intermediate flow path 150. With FIG. 1, the sensing section 105 is arranged in the space at the back side of the circuit board 13. Though omitted from the drawing, the sensing section 105 is equipped with a cavity that forms part of the wall surface of the intermediate flow path 150, a vibrating plate forming part of the cavity wall surface, and a piezoelectric element arranged on the vibrating plate. The terminal of the piezoelectric element is electrically connected to part of the electrode terminal of the circuit board 13, and when the ink cartridge 100 is installed in the inkjet printer, the terminal of the piezoelectric element is electrically connected to the inkjet printer via the electrode terminal of the circuit board 13. The inkjet printer can make the vibrating plate vibrate via the piezoelectric element by applying electrical energy to the piezoelectric element. After that, by detecting via the piezoelectric element the characteristics (frequency and the like) of the residual vibration of the vibrating plate, the inkjet printer is able to detect the presence or absence of ink in the cavity. In specific terms, by the ink stored in the ink cartridge 100 being used up, when the cavity internal state changes from an ink-filled state to an air-filled state, the characteristics of the residual vibration of the vibrating plate change. By these changes in the vibrating characteristics being detected via the piezoelectric element, the inkjet printer is able to detect the presence or absence of ink in the cavity.

When manufacturing the ink cartridge 100, as the liquid surface is conceptually shown by the dashed line ML1, the ink is filled up to the ink storage chamber 140. As the ink inside the ink cartridge 100 is consumed by the inkjet printer, the liquid surface moves to the downstream side, and in its place, air flows in to inside the ink cartridge 100 from upstream via the air opening hole 130a. Then, when ink consumption advances, as the liquid surface is conceptually shown by the dashed line ML2, the liquid surface reaches the sensing section 105. When this is done, air is introduced into the cavity of the sensing section 105, and running out of ink is detected by the piezoelectric element of the sensing section 105. When running out of ink is detected, the ink cartridge 100 stops printing at the stage before the ink existing at the downstream side of the sensing section 105 (buffer chamber 160 and the like) is completed consumed, and notifies the user that the ink is running out. This is because there is the risk that when the ink completely runs out, when further printing is performed, air is mixed into the printing head, which would cause problems.

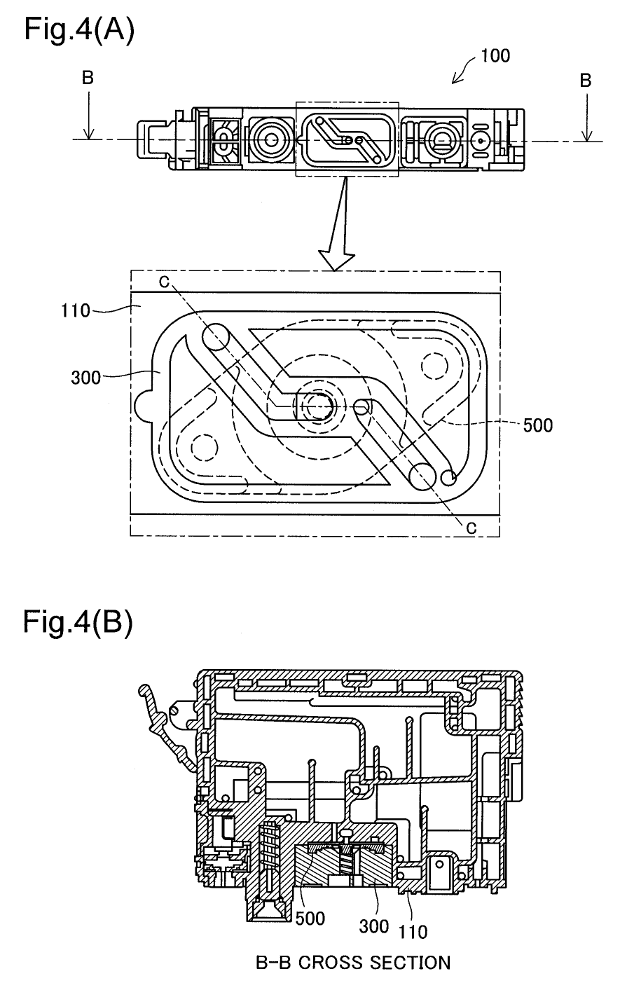

FIG. 4 are first drawings for describing the constitution of the valve section. The valve section 180 includes a spring seat member 300 arranged at roughly the center of the bottom surface of the main body 110, and a membrane valve 500 arranged between one surface of the spring seat member (with this embodiment, the top surface of the spring seat member) and the main body 110.

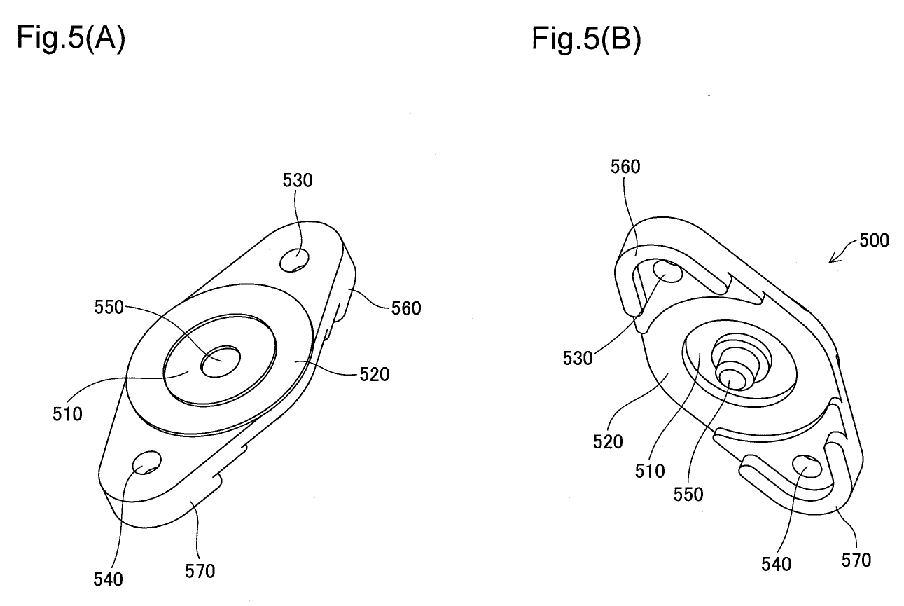

FIG. 5 are first drawings showing the constitution of the membrane valve 500. The membrane valve 500 is created with a resin type elastomer which has overall elasticity. The specific gravity of the elastomer used with the membrane valve 500 is smaller than the specific gravity of the ink. The membrane valve 500 has an axis portion 550, a membrane portion 510, a seal portion 520, a first installing portion 560, and a second installing portion 570. Of the surfaces of the membrane valve 500, the side shown in FIG. 5 (A) is called the first surface. Meanwhile, of the surfaces of the membrane valve 500, the side shown in FIG. 5 (B) is called the second surface. A first assembly hole 530 is formed on the first installing portion 560, and a second assembly hole 540 is formed on the second installing portion 570. By fitting these assembly holes 530 and 540 in the convex part (not illustrated) of one side of the spring seat member 300 (with this embodiment, the top part of the spring seat member 300), the membrane valve 500 is fixed to the one side (with this embodiment, the top part) of the spring seat member 300.

The membrane portion 510 has a ring shape that encloses the periphery of the axis portion 550. The seal portion 520 has a ring shape that encloses the outer periphery of the membrane portion 510.

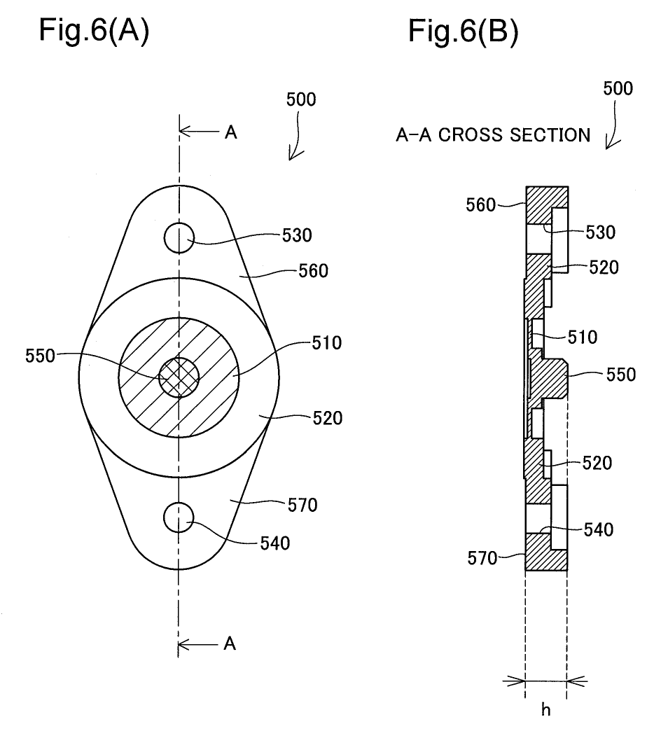

FIG. 6 are second drawings showing the constitution of the membrane valve 500. FIG. 6 (A) is a front view of the membrane valve 500 seen from the first surface side. FIG. 6 (B) is a drawing showing the A-A cross section of FIG. 6 (A). In the part of the first surface side of the axis portion 550, specifically, in FIG. 6 (A), the cross hatched area is the contact area that is in contact with that is contact with the upstream end of the relay flow path described later. The membrane portion 510 has a thickness that is relatively thin compared to other parts as shown in FIG. 6 (B), so it is deformed easily. In the part of the first surface side of the membrane portion 510, specifically, in FIG. 6 (A), the single-hatched area is the upstream side pressure receiving area that receives the fluid pressure of the ink that flows in the valve upstream path 170. The side opposite the upstream side pressure receiving area, specifically, the second surface side, is the downstream side pressure receiving area that receives the fluid pressure of ink that flows in the valve downstream path 190. As shown in FIG. 6 (B), the maximum thickness of the first installing portion 560, the maximum thickness of the second installing portion 570, and the maximum thickness of the axis portion 550 are designed to have an equal value h. This is because it is possible to laminate a plurality of the membrane valve 500 stably when transporting the plurality of the membrane valve 500 as parts.

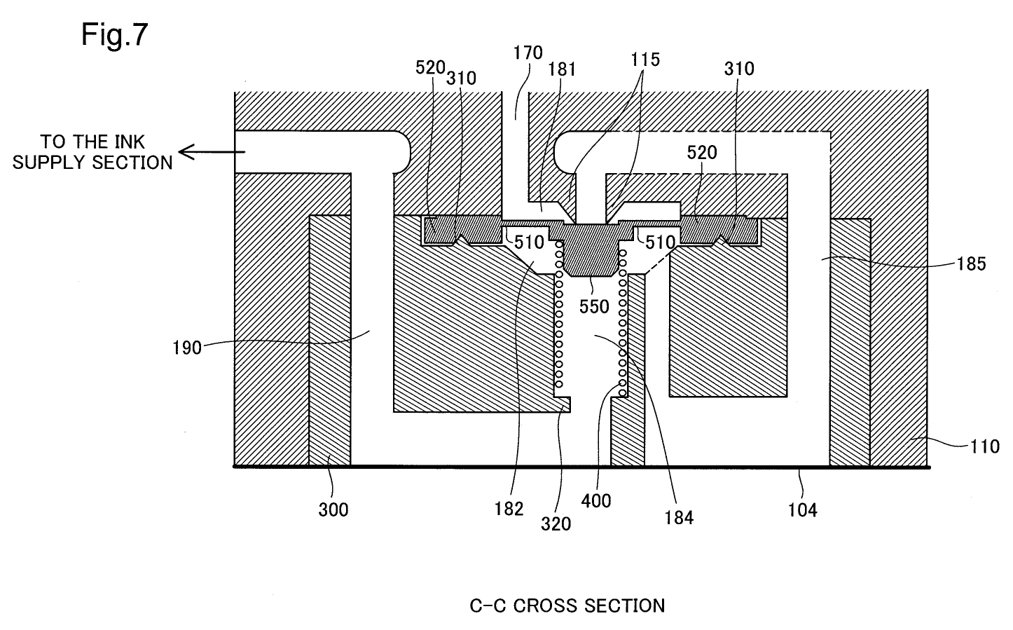

FIG. 7 is a second drawing for describing the constitution of the valve section 180. FIG. 7 corresponds to the C-C cross section in FIG. 4. FIG. 7 shows the closed valve state (non-linked state) for which the membrane valve 500 blocks between the valve upstream path 170 and the valve downstream path 190. As can be understood from FIG. 7, in a state with the ink cartridge 100 installed in the carriage 200, the contact area is low or sinks in from the upstream side pressure receiving area, and is in a low position in the gravitational force direction. Formed on the valve section 180 are an upstream valve chamber 181, a downstream valve chamber 182, a spring accommodating chamber 184, and a relay flow path 185. The upstream valve chamber 181 is formed as a compartment by a shape formed on the main body 110 and the first surface of the membrane valve 500. The downstream valve chamber 182 is formed as a compartment by a shape formed on the spring seat member 300 and the second surface of the membrane valve 500. The downstream valve chamber 182 has a tapered shape that is deeper the closer it goes toward the center of the circle, and becomes shallower the more it goes toward the outside. The spring accommodating chamber 184 is formed on the spring seat member 300 and has a round cylinder shape. A coil spring 400 is stored as the urging member in the spring accommodating chamber 184. The end of one side of the spring accommodating chamber 184 (with this embodiment, the top end of the spring accommodating chamber 184) is linked to the downstream valve chamber 182, a spring supporting portion 320 that supports the spring is formed at the other side of the spring accommodating chamber 184 (with this embodiment, the lower side of the spring accommodating chamber 184), and the other side of the spring accommodating chamber 184 (with this embodiment, the lower side) is linked to the valve downstream path 190. As shown in the drawing, with the valve downstream path 190, the upstream part is formed as a compartment by the shape formed on the spring seat member 300 and the second bottom film 104, and the downstream part is formed on the main body 110. With the relay flow path 185, the upstream part is formed on the main body 110, and the downstream part is formed as a compartment by the shape formed on the spring seat member 300 and the second bottom film 104. The upstream end part of the relay flow path 185 has an apex shape 115, and is in contact with the contact area of the membrane valve 500 when in a closed valve state. The downstream end of the relay flow path 185 is linked to the downstream valve chamber 182.

The coil spring 400 urges the axis portion 550 of the membrane valve 500 in the direction toward the apex shape 115 (with this embodiment, the top side). Also, the fluid pressure of the valve downstream path 190 is applied to the second surface of the membrane valve 500 via the downstream valve chamber 182. This urging force and the fluid pressure of the valve downstream path 190 become the force that tries to maintain the closed valve state of the membrane valve 500 (closed valve force). Meanwhile, the fluid pressure of the valve upstream path 170 is applied to the first surface of the membrane valve 500. The fluid pressure of this valve upstream path 170 becomes the force that tries to achieve the open valve state of the membrane valve 500 (open valve force).

The seal portion 520 of the membrane valve 500 is gripped between the main body 110 and the spring seat member 300. With the spring seat member 300, at the part that grips the seal portion 520, the rib 310, of which the cross section is triangular, is formed in a ring shape when seen from the surface on which the membrane valve 500 is installed (with this embodiment, the top surface). By the rib 310 being pressed against the seal portion 520, leaking of the ink to outside the seal portion 520 is suppressed.

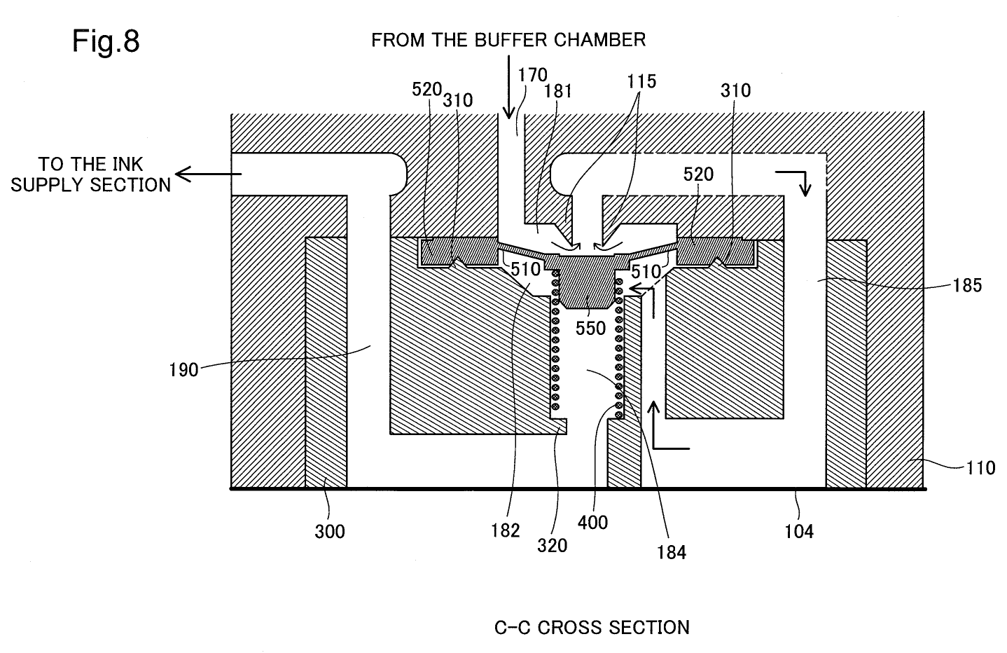

FIG. 8 is a third drawing for describing the constitution of the valve section 180 of the first embodiment. When ink is consumed by the inkjet printer, ink is supplied from the ink supply section to the inkjet printer. By doing this, the fluid pressure of the valve downstream path 190 decreases. If the closed valve force in relation to the membrane valve 500 by the decrease of the fluid pressure of the valve downstream path 190 becomes lower than the open valve force in relation to the membrane valve 500, the membrane portion 510 of the membrane valve 500 is deformed, and the axis portion 550 moves in the direction separating from the apex shape 115 (with this embodiment, downward). As a result, a gap is formed between the apex shape 115 and the contact area of the membrane valve 500, and the valve upstream path 170 goes to a state linked to the valve downstream path 190 via the relay flow path 185 and the downstream valve chamber 182 (open valve state). With this open valve state, ink is flowed into the relay flow path 185 from the valve upstream path 170, and as a result, ink flows into the valve downstream path 190. By this inflow of ink, the fluid pressure of the valve downstream path 190 rises, and as a result, when the valve close force exceeds the valve open force, the membrane portion 510 is again deformed, and the membrane valve 500 returns to a closed valve state.

Because the urging force of the coil spring 400 is added, the fluid pressure of the valve downstream path 190 is kept lower than the fluid pressure of the valve upstream path 170 which receives atmospheric pressure. Specifically, the pressure of the ink inside the valve downstream path 190 is normally kept at a negative pressure lower than atmospheric pressure, and as a result, it is possible to suppress ink leakage from the ink supply section 120 of the ink cartridge 100.

With the first embodiment described above, the membrane valve 500 is formed using an elastomer, so the deformation of the membrane portion 510 in relation to the fluid pressure is stabilized. As a result, the negative pressure generated in the ink inside the valve downstream path 190 is also stabilized.

Furthermore, the membrane valve 500 is arranged so that the membrane portion 510 is roughly perpendicular in relation to the gravitational force direction. As a result, there is little variation due to gravitational force of the fluid pressure applied to the membrane portion 510. As a result, the deformation of the membrane portion 510 is stabilized, so the negative pressure generated in the ink inside the valve downstream flow path 190 is also stabilized.

Furthermore, with the state in which the ink cartridge 100 is installed in the carriage 200, the contact area of the first surface of the membrane valve 500 is in a position lower than the upstream side pressure receiving area, so ink is not easily left remaining in the upstream valve chamber 181. As a result, the ink volume remaining inside the ink cartridge 100 is suppressed, and it is possible to supply a greater amount of ink to the inkjet printer.

Furthermore, the specific gravity of the membrane valve 500 is lower than the specific gravity of the ink, so force is applied by the buoyancy force on the membrane valve 500 in the direction facing the apex shape 115 (with this embodiment, the upward). As a result, it is possible to make the coil spring 400 compact.

### B. Second Embodiment

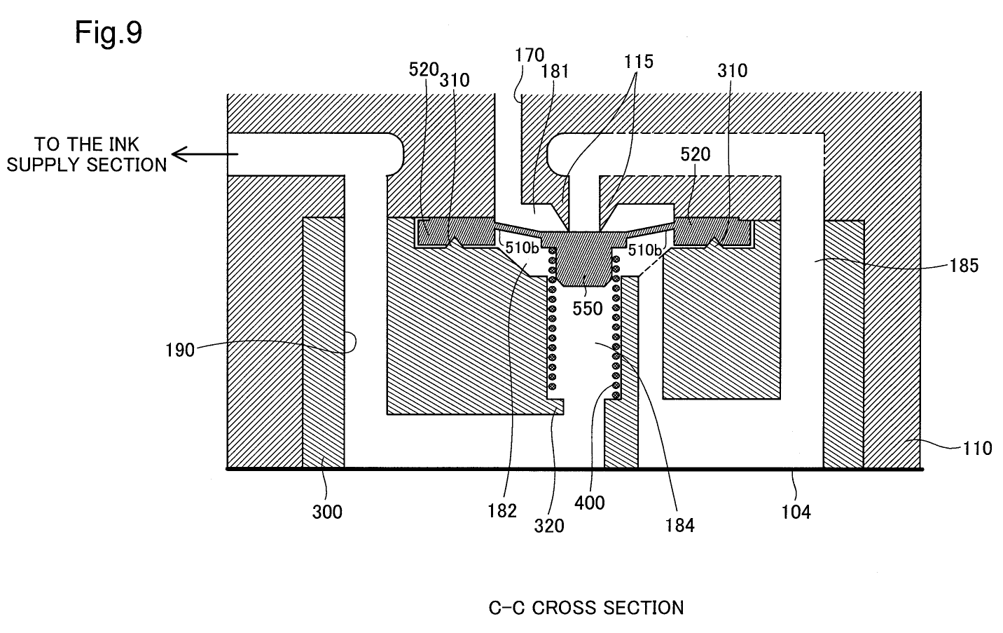

FIG. 9 is a drawing for describing the constitution of the valve section 180 of the second embodiment. With the membrane portion 510b of the second embodiment, in contrast to the membrane portion 510b of the first embodiment, this is formed diagonally rather than horizontally in the closed valve state of the membrane valve 500. Specifically, 510b of the second embodiment has an incline that is lower the more it faces the center of the membrane valve 500, and higher the more it faces the outside of the membrane valve 500. As a result, the fluid of the upstream valve chamber 181 is gathered near the contact area, so ink does not easily remain in the upstream valve chamber 181. As a result, the ink volume that remains inside the ink cartridge 100 is suppressed, and it is possible to supply a larger volume of ink to the inkjet printer.

### C. Third Embodiment

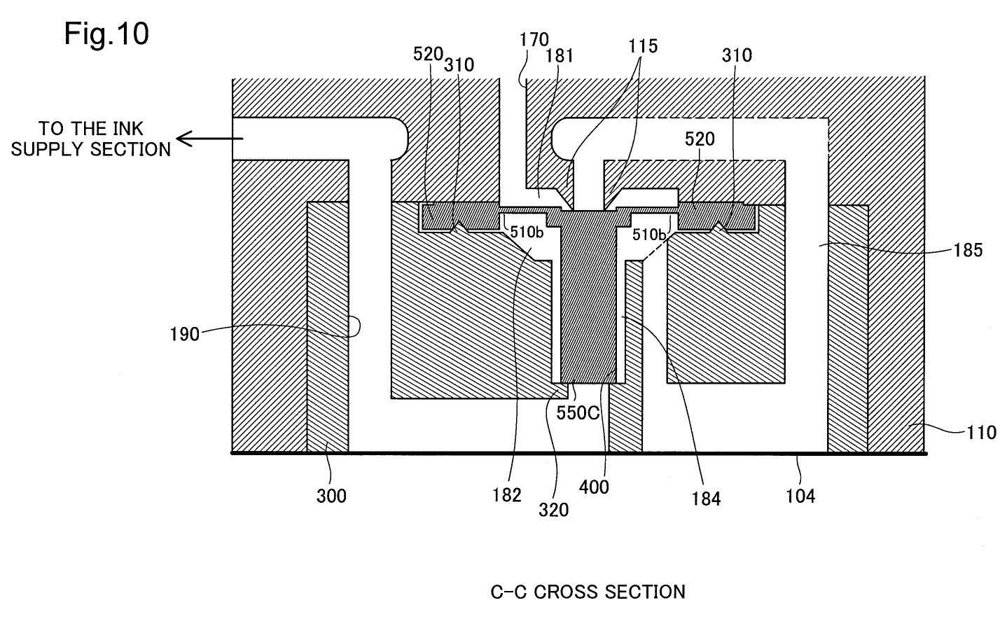

FIG. 10 is a drawing for describing the constitution of the valve section 180 of the third embodiment. There is no coil spring 400 in the valve section 180 of the third embodiment. With the membrane valve 500 of the third embodiment, the axis portion 550c is extended along the spring accommodating chamber 184 side (with this embodiment, downward), and reaches the spring supporting portion 320. Specifically, the cylindrical part of the spring accommodating chamber 184 side (with this embodiment, the lower portion) of the axis portion 550 functions in place of the coil spring 400 as an urging member that urges the membrane valve 500 to the apex shape 115 side. Working in this way, by making the membrane valve 500 and the urging member a single unit, it is possible to reduce the number of parts.

With the first through third embodiments described above, the upstream valve chamber 181 correlates to the “first chamber” in the claims, and the downstream valve chamber 182 correlates to the “second chamber.” Also, the relay flow path 185 correlates to the “communication flow path,” and the membrane valve 500 correlates to the “moveable membrane.” Also, the spring accommodating chamber 184 correlates to the “concave portion for receiving one end of the coil spring.” Also, the valve section 180 correlates to the “differential pressure regulating valve,” the ink storage chamber 140 correlates to the “fluid storage chamber,” the supply port 120a correlates to the “fluid supply port,” and the ink supply section 120 correlates to the “fluid supply section.”

Then, the ink paths of the first to third embodiment have the following advantages in addition to the operation and effects described previously. For example, to convey the pressure to the membrane valve 500, it is possible to use a dead end flow path that branches from the ink path and reaches the membrane valve 500. However, when using this kind of dead end flow path, it is easy for ink to remain in the dead end flow path. Meanwhile, with these embodiments, the ink path goes through the upstream valve chamber 181 and the downstream valve chamber 182 connected serially via the relay flow path. Specifically, the respective upstream valve chamber 181 and the downstream valve chamber 182 are not dead ends. Therefore, compared to when at least one of the upstream valve chamber 181 and the downstream valve chamber 182 is a dead end flow path, it is possible to reduce the volume of ink left remaining in the valve chambers 181 and 182 without being consumed when the ink residual volume is decreased. Also, when filling the ink cartridge with ink, it is possible to reduce the possibility of air remaining in the valve chambers 181 and 182. Therefore, it is possible to reduce the possibility of air that would remain in the valve chambers 181 and 182 being accidentally supplied to the inkjet printer.

In particular, with the first to third embodiments, the constitution is such that ink flows out from the bottom wall of the spring accommodating chamber 184 (the concave portion). In other words, an ink outflow port for the downstream valve chamber 182 is formed on the bottom wall of the spring accommodating chamber 184. Therefore, when the ink residual volume decreases, by flowing air introduced to the spring accommodating chamber 184 to the outflow port, it is possible to assist exhausting of ink across the entire spring accommodating chamber 184. Therefore, compared to when the ink outflow port is formed on the side wall of the spring accommodating chamber 184, the volume of ink remaining in the spring accommodating chamber 184 can be effectively reduced. However, the outflow port does not absolutely have to be formed on the bottom wall of the spring accommodating chamber 184, but can also be formed on the side wall.

Also, with the first and second embodiments, the coil spring 400 urges the contact area toward the outflow port on the upstream valve chamber 181 (opening that surrounds the apex shape 115). Also, with the third embodiment, instead of the coil spring, the axis portion 550C is used as the urging member. Therefore, it is possible to decrease the possibility of the contact area unintentionally separating from the apex shape 115 and the outflow port opening. As a result, it is possible to stabilize the negative pressure generated on the ink inside the valve downstream path 190.

Also, with the first to third embodiments, there was no hole in the part that receives the pressure of the upstream valve chamber 181 and the part that receives the pressure of the downstream valve chamber 182. In specific terms, there is no hole in the axis portion 550 and the membrane portion 510. Therefore, it is possible to reduce the possibility of unintended deformation of the membrane valve 500. As a result, it is possible to reduce the possibility of the outflow port (the opening that surrounds the apex shape 115) of the upstream valve chamber 181 unintentionally opening. Then, it is possible to stabilize the negative pressure generated on the ink within the valve downstream path 190. Also, compared to when a hole is provided on the membrane valve 500K for flowing ink, it is possible to decrease the resistance to the ink flow.

Note that with the second and third embodiments, only the parts that are different from the first embodiment are described, but it is possible to constitute the other portions in the same manner as those of the first embodiment, and for the portions that are constituted in the same way as those of the first embodiment, it is possible to obtain the same effect as that of the first embodiment.

### D. Fourth Embodiment

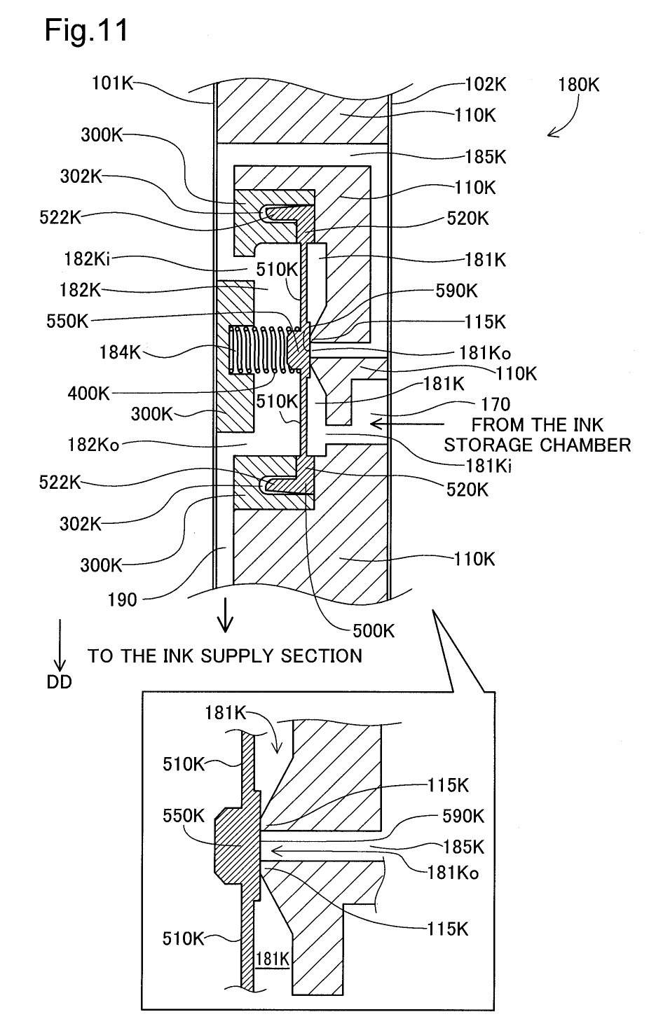

FIG. 11 is an explanatory drawing showing the constitution of the valve section 180K of the fourth embodiment. The constitution of the valve section 180K is the same as a constitution obtained by changing the direction of the valve section 180 (the entirety of the spring set member 300, the membrane valve 500, and the part that receives the spring seat member 300 of the main body 110) shown in FIG. 4 (A) and 4 (B) so that the membrane valve 500 is roughly parallel to the gravitational force direction DD. Note that with the valve section 180K of this embodiment, the respective shapes of the flow path, the valve chamber, and the membrane valve 500 are slightly different from the shapes of the embodiments shown in FIG. 4 to FIG. 8. Also, the detailed constitution of the flow path of the main body 110K is different from the constitution of the embodiment shown in FIG. 1. However, another constitution of the ink cartridge of the embodiment is the same as the constitution of the ink cartridge of the first embodiment shown in FIG. 1 to 3 (not illustrated). Also, the overview of the path that reaches from the air opening holes to the fluid supply section with this embodiment is the same as that in FIG. 3 (the valve section 180 in FIG. 3 is replaced with the valve section 180K of this embodiment).

FIG. 11 shows the cross section view in the same way as FIG. 7. FIG. 11 shows the closed valve state (non-linked state) with the membrane valve 500K blocking between the valve upstream path 170 and the valve downstream path 190. With the first embodiment (see FIG. 4), the spring seat member 300 is fit facing from bottom to top in the bottom surface of the main body 110. With this embodiment, the spring seat member 300K is fit in one of the side surfaces of the main body 110K facing from that one side surface toward the other side surface. The membrane valve 500K, the same as with the first embodiment (see FIG. 7) is sandwiched between the main body 110K and the spring seat member 300K. The same as with the first embodiment (see FIG. 1), side films 101K and 102K are respectively adhered to both side surfaces of the main body 110K. The first side film 101K is adhered to the main body 110K and the spring seat member 300K, forming the various types of flow paths and chambers. The second side film 102K is adhered to the opposite side of the main body 110K, forming the various types of flow paths and chambers. Note that in FIG. 11, the spring seat member 300K is represented by a plurality of separate parts, but with this embodiment, the spring seat member 300K is one single member formed three dimensionally. Also, in FIG. 11, the main body 110K is represented by a plurality of separate parts, but with this embodiment, the main body 110K is formed as one single member formed three dimensionally.

Formed on the valve section 180K are the upstream valve chamber 181K, the downstream valve chamber 182K, the spring accommodating chamber 184K, and the relay flow path 185K. The upstream valve chamber 181K is formed by the shape formed on main body 110K and one of the surfaces of the membrane valve 500K (correlates to the “first surface”). The downstream valve chamber 182K is formed by the shape formed on the spring seat member 300K and the other surface of the membrane valve 500K (correlates to the “second surface”). In this way, the space between the main body 110K and the spring seat member 300K are partitioned by the membrane valve 500K.

The upstream valve chamber 181K is a ring shaped space similar to the upstream valve chamber 181 of FIG. 7. An inflow port 181Ki is provided on the inner wall of the upstream valve chamber 181K. With this inflow port 181Ki, the downstream end of the valve upstream path 170 is connected to the upstream valve chamber 181K. Specifically, the valve upstream path 170 is linked to the upstream valve chamber 181K via the inflow port 181Ki. Also, the apex shape 115K that has the same shape as the apex shape 115 shown in FIG. 7 is formed at the position facing opposite the membrane valve 500K of the inner wall of the upstream valve chamber 181K. The apex shapes 115 and 115K are projecting parts of a loop shape that projects toward the membrane valves 500 and 500K. At the bottom of FIG. 11 is shown an enlarged view of a part containing the apex shape 115K. An opening 181Ko enclosed by the apex shape 115K is closed by the contact area 590K of the membrane valve 500K. Also, this opening 181Ko is the upstream end of the relay flow path 185K. Hereafter, the opening 181Ko is also called the “outflow port 181Ko.”

With this embodiment, the shape of the downstream valve chamber 182K is a roughly cylindrical column shaped space. The spring accommodating chamber 184K is formed on the inner wall facing opposite the membrane valve 500K of the downstream valve chamber 182K. The spring accommodating chamber 184K is a roughly cylindrical column shaped concave portion. One end of the coil spring 400K is inserted in the spring accommodating chamber 184K. The axis portion 550K of the membrane valve 500K is inserted in the other end of the coil spring 400K. The outflow port 182Ko is formed at the lower position separated from the spring accommodating chamber 184K of the inner wall of the downstream valve chamber 182K. With the outflow port 182Ko, the upstream end of the valve downstream path 190 is connected to the downstream valve chamber 182K. Specifically, the valve downstream path 190 is linked to the downstream valve chamber 180K via the outflow port 182Ko. The inflow port 182Ki is formed at the upper position separated from the spring accommodating chamber 184K of the inner wall of the downstream valve chamber 182K. With the inflow port 182Ki, the downstream end of the relay flow path 185K is connected to the downstream valve chamber 182K. Specifically, the relay flow path 185K is linked to the downstream valve chamber 182K via the inflow port 182Ki.

The constitution of the membrane valve 500K is the same as the constitution obtained by respectively substituting the axis portion 550, the membrane portion 510, and the seal portion 520 of the membrane valve 500 shown in FIG. 5 and FIG. 6 with the axis portion 550K, the membrane portion 510K, and the seal portion 520K described below. Note that as will be described later, with the membrane valve 500K, it is also possible to omit installing portions 560 and 570.

The axis portion 550K contains the projecting part inserted in the inside of one end of the coil spring 400K. The membrane portion 510K is connected along the entire periphery on the outer periphery of the axis portion 550K. The membrane portion 510K has a ring shape enclosing the outer periphery of the axis portion 550K. The seal portion 520K is connected along the entire periphery on the outer periphery of the membrane portion 510K. The seal portion 520K has a ring shape enclosing the outer periphery of the membrane portion 510K. The same as with the first embodiment (FIG. 7 and FIG. 8), the thickness of the membrane portion 510K is thinner than the other parts of the membrane valve 500K. Therefore, the membrane portion 510K is easily deformed. Provided on the upstream valve chamber 181K side of the axis portion 550K is the contact area 590K that contacts the apex shape 115K and closes the opening 181Ko. With this embodiment, the contact area 590K projects to the apex shape 115K side more than the first surface of the membrane portion 510K. Also, the axis portion 550K has a projecting part that projects to the downstream valve chamber 182K side, and that projecting part is inserted to the inside of the end of the coil spring 400K. The coil spring 400K urges the axis portion 550K (contact area 590K) toward the opening 181Ko.

The seal portion 520K is sandwiched by the main body 110K and the spring seat member 300K in the same way as with the first embodiment (see FIG. 7 and FIG. 8), and seals between the upstream valve chamber 181K and the downstream valve chamber 182K. Note that with this embodiment, at the outer periphery part of the seal portion 520K, a projecting part 522K is provided that projects toward the spring seat member 300K. The overall shape of this projecting part 522K is a roughly circular cylindrical shape. A groove 302K in which the projecting part 522K is inserted is formed on the spring seat member 300K. By having the projecting part 522K inserted in the groove 302K, it is possible to determine the position of the membrane valve 500K with good precision.

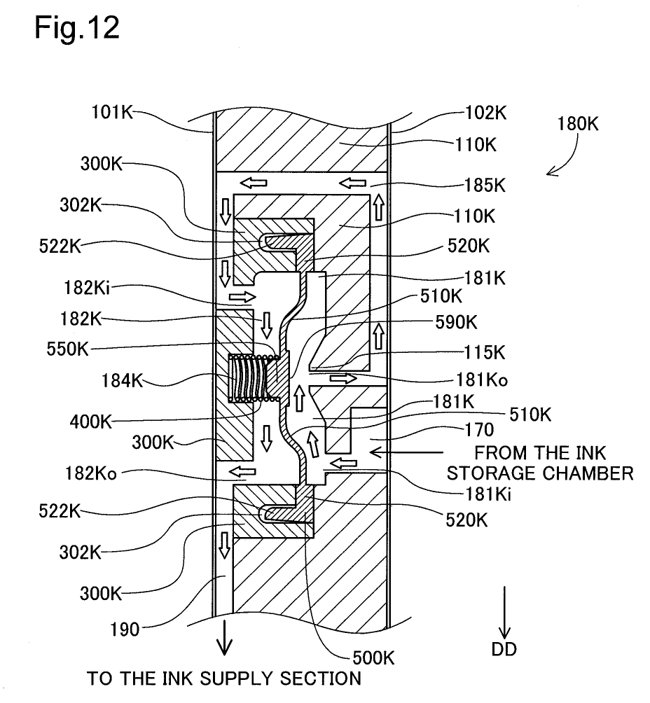

FIG. 12 is an explanatory drawing showing the open valve state of the valve section 180K. FIG. 12 shows the same cross section as FIG. 1. The opening and closing mechanism of the valve section 180K is the same as the opening and closing mechanism of the first embodiment (see FIG. 7 and FIG. 8). By consumption of the ink, the pressure (fluid pressure) of the valve downstream path 190, specifically, the downstream valve chamber 182K, decreases. When the difference in pressure in the upstream valve chamber 181K in relation to the pressure in the downstream valve chamber 182K (differential pressure) exceeds a specified pressure, the membrane portion 510K deforms and the axis portion 550K (contact area 590K) moves in the direction separating from the opening 181Ko. As a result, a gap is formed between the apex shape 115K and the contact area 590K, and the valve upstream path 170 is linked to the valve downstream path 190 via the relay flow path 185K. In this state, ink flows into the valve downstream path 190 via the relay flow path 185K from the valve upstream path 170. By this inflow of ink, the pressure inside the valve downstream path 190 rises, the differential pressure goes to a specified pressure or less, and the membrane valve 500K returns to the closed valve state.

In this way, it is also possible for the membrane valve 500K to be roughly parallel to the gravitational force direction DD. In this case as well, by the membrane portion 510K deforming according to the difference between the pressure of the upstream valve chamber 181K and the pressure of the downstream valve chamber 182K (differential pressure), the membrane valve 500K is able to suitably open and close the outflow port 181Ko. In particular, as shown in FIG. 11 and FIG. 12, the outflow port 181Ko is arranged at a position facing opposite the membrane valve 500K, so it is possible to easily realize opening and closing according to differential pressure. Also, the movement direction of the contact area 590K is roughly perpendicular to the gravitational force direction DD, so it is possible to reduce the effect of gravitational force on the movement of the contact area 590K. Note that the contact area 590K correlates to the “movable seal” in the claims. The contact area shown in FIG. 6 (A) (axis portion 550) also correlates to the “movable seal.”

Also, the ink path of this embodiment has the following advantages. For example, to convey the pressure to the membrane valve 500K, it is possible to branch from the ink path and use the dead end flow path that reaches the membrane valve 500K. However, when using this kind of dead end flow path, it is easy for ink to remain inside the dead end flow path. Meanwhile, with this embodiment, the ink path goes through the upstream valve chamber 181K and the downstream valve chamber connected serially via the relay flow path 185K. Specifically, neither of the upstream valve chamber 181K or the downstream valve chamber 182K is a dead end path. Therefore, compared to when at least one of the upstream valve chamber 181K and the downstream valve chamber 182K is a dead end flow path, it is possible to decrease the volume of ink remaining in the valve chambers 181K and 182K without being consumed when the ink residual volume is decreased. Also, when ink is filled in the ink cartridge, it is possible to decrease the possibility of air remaining in the valve chambers 181K and 182K. Therefore, it is possible to reduce the possibility of air remaining in the valve chambers 181K and 182K accidentally being supplied to the inkjet printer.

Also, as shown in FIG. 11 and FIG. 12, with this embodiment, the outflow port 182Ko of the downstream valve chamber 182K is arranged at the bottommost position of the gravitational force direction DD of the downstream valve chamber 182K. Therefore, it is possible to decrease the ink volume that remains in the downstream valve chamber 182K without being consumed when the ink residual volume is decreased.

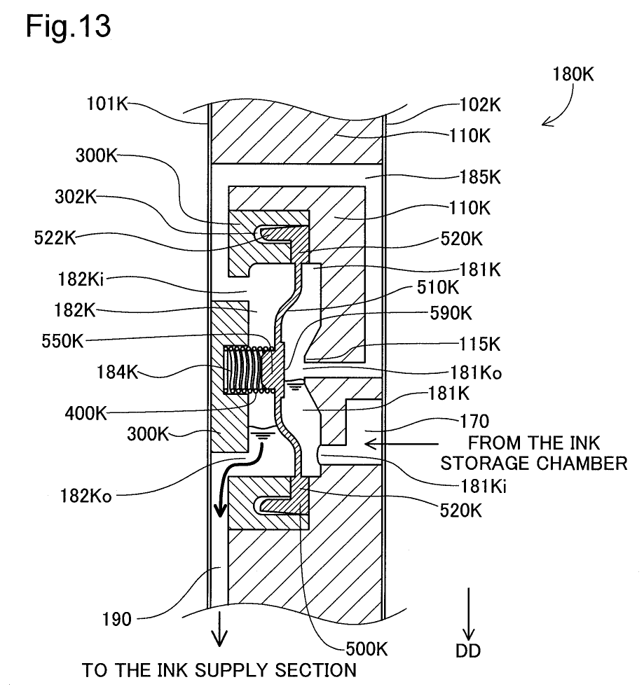

Also, with this embodiment, the valve downstream path 190 extends facing down from the outflow port 182Ko, so it is possible to easily supply ink within the downstream valve chamber 182K to the valve downstream path 190. FIG. 13 is an explanatory drawing showing the state with the ink residual volume decreased. FIG. 13 shows the same cross section as FIG. 11 and FIG. 12. FIG. 13 shows the state when the air introduced from the air opening hole 130a (FIG. 3) reaches the valve section 180K by the consumption of ink. The air that reaches the upstream valve chamber 181K is introduced to the upper part of the upstream valve chamber 181K. By doing this, the ink that exists in the upper part of the upstream valve chamber 181K is supplied to the downstream valve chamber 182K through the relay flow path 185K. Furthermore, when ink is consumed, the ink existing in the relay flow path 185K is supplied to the downstream valve chamber 182K, and air is introduced to the relay flow path 185K. FIG. 13 shows this state. With the state shown in FIG. 13, a tiny amount of ink remains in the part lower than the outflow port 181Ko of the upstream valve chamber 181K. However, the ink inside the downstream valve chamber 182K is led to the valve downstream path 190 through the outflow port 182Ko by gravitational force. Therefore, it is possible to effectively reduce the volume of ink that remains in the downstream valve chamber 182K.

Also, as shown in FIG. 11 and FIG. 12, with this embodiment, the coil spring 400K urges the contact area 590K toward the outflow port 181Ko. Therefore, it is possible to reduce the possibility of the contact area 590K unintentionally separating from the apex shape 115K and the outflow port 181Ko opening. As a result, it is possible to stabilize the negative pressure generated on the ink inside the valve downstream path 190. The embodiment of FIG. 7 to FIG. 11 has the same advantages (with the embodiment of FIG. 10, the axis portion 550C is used as the urging member instead of the coil spring).

Also, with this embodiment, there are no holes in the part that receives the pressure of the upstream valve chamber 181K and the part that receives the pressure of the downstream valve chamber 182K of the membrane valve 500K. In specific terms, there are no holes in the axis portion 550K and the membrane portion 510K. Therefore, it is possible to reduce the possibility of unintended deformation of the membrane valve 500K. As a result, it is possible to reduce the possibility of the outflow port 181Ko unintentionally opening. Then, it is possible to stabilize the negative pressure generated on the ink inside the valve downstream path 190. Also, compared to when holes to flow ink are provided in the membrane valve 500K, it is possible to reduce the resistance to the ink flow (when holes for flowing ink are provided in the membrane valve, to reduce the possibility of unintended deformation of the membrane valve, there were many cases of adopting holes with a small diameter).

### E. Fifth Embodiment

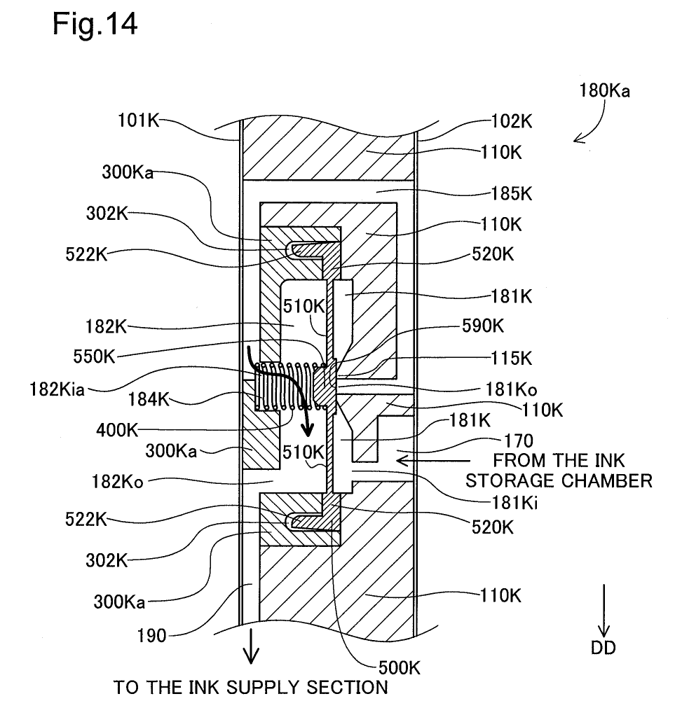

FIG. 14 is an explanatory drawing showing the constitution of the valve section 180Ka of the fifth embodiment. FIG. 14 shows the cross section in the same way as that of FIG. 11 and FIG. 12. The difference from the valve section 180K of the fifth embodiment (see FIG. 11 and FIG. 12) is that the inflow port 181Kia of the downstream valve chamber 182K is provided in the spring accommodating chamber 184. The remainder of the constitution of the valve section 180Ka is the same as the constitution of the valve section 180K in FIG. 11 and FIG. 12.

With the inflow port 182Kia, the downstream end of the relay flow path 185K is connected to the downstream valve chamber 182K. In other words, the relay flow path 185K and the downstream valve chamber 182K are linked via the inflow port 182Kia. When the ink residual volume is reduced, the air introduced from the air opening hole 130a of FIG. 3 is introduced to the spring accommodating chamber 184K via the inflow port 182Kia. The introduced air can assist the exhausting of ink from the spring accommodating chamber 184K. Therefore, compared to when the spring accommodating chamber 184K is a dead end path, it is possible to reduce the volume of ink remaining in the spring accommodating chamber 184K without being consumed when the ink residual volume is decreased. In particular, with this embodiment, the inflow port 182Kia is formed on the bottom wall of the spring accommodating chamber 184K (concave portion). Therefore, when the ink residual volume is reduced, the air introduced to the spring accommodating chamber 184K is able to assist the exhausting of ink across the entire spring accommodating chamber 184K. As a result, compared to when the inflow port 182Kia is formed on the side wall of the spring accommodating chamber 184K, it is possible to effectively reduce the volume of ink that remains in the spring accommodating chamber 184K. However, the inflow port can also be formed on the side wall of the spring accommodating chamber 184K. Note that the remainder of the constitution of the valve section 180Ka is the same as the constitution of the valve section 180K of the fourth embodiment (see FIG. 11 and FIG. 12) (in FIG. 14, the elements that are the same element as FIG. 11 and FIG. 12 are given the same codes). Therefore, the valve section 180Ka of this embodiment has the same various advantages as the valve section 180K of the fourth embodiment. Note that the shape of the part of the inflow port between the spring seat member 300Ka of this embodiment and the spring seat member 300K of the fourth embodiment is different.

### F. Sixth Embodiment

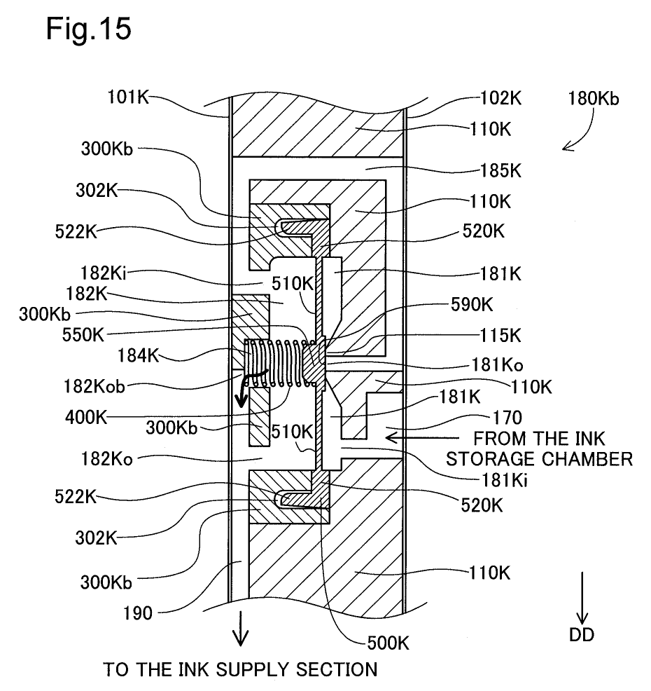

FIG. 15 is an explanatory drawing showing the constitution of the valve section 180Kb of the sixth embodiment. FIG. 15 shows the same cross section as that of FIG. 11 and FIG. 12. The difference from the valve section 180K of the fourth embodiment (see FIG. 11 and FIG. 12) is that an additional outflow port 182Kob of the downstream valve chamber 182K is provided on the spring accommodating chamber 184K. The remainder of the constitution of the valve section 180Kb is the same as the constitution of the valve section 180K of the fourth embodiment.

With the outflow port 182Kob, the valve downstream path 190 is connected to the downstream valve chamber 182K. In other words, the valve downstream path 190 and the downstream valve chamber 182K are linked via the inflow port 182Koa. When the ink residual volume is decreased, the air introduced from the air opening hole 130a of FIG. 3 is introduced from the spring accommodating chamber 184K to the valve downstream path 190 via the outflow port 182Kob. This air can assist the exhausting of ink from the spring accommodating chamber 184K. Therefore, compared to when the spring accommodating chamber 184K is a dead end path, it is possible to reduce the volume of ink remaining in the spring accommodating chamber 184K without being consumed when the ink residual volume is decreased. In particular, with this embodiment, the outflow port 182Kob is formed on the bottom wall of the spring accommodating chamber 184K (concave portion). Therefore, when the ink residual volume is decreased, by the air introduced to the spring accommodating chamber 184K being flowed to the outflow port 182Kob, it is possible to assist the exhausting of ink across the entire spring accommodating chamber 184K. Therefore, compared to when the outflow port 182Kob is formed on the side wall of the spring accommodating chamber 184K, it is possible to effectively decrease the volume of ink remaining in the spring accommodating chamber 184K. However, the outflow port does not absolutely have to be formed on the bottom wall of the spring accommodating chamber 184K, but can also be formed on the side wall.

Note that with this embodiment, the ink inside the downstream valve chamber 182K flows to the valve downstream path 190 through the two outflow ports 182Ko and 182Kob. Also, the remainder of the constitution of the valve section 180Kb is the same as the constitution of the valve section 180K of the fourth embodiment (see FIG. 11 and FIG. 12) (in FIG. 14, the elements that are the same as the elements of the fourth embodiment are given the same code number). Therefore, the valve section 180Kb of this embodiment has the same various advantages as the valve section 180K of the fourth embodiment. Note that the shape of the part of the outflow port 182Kob between the spring seat member 300Kb of this embodiment and the spring seat member 300K of the fourth embodiment is different.

### G. Seventh Embodiment

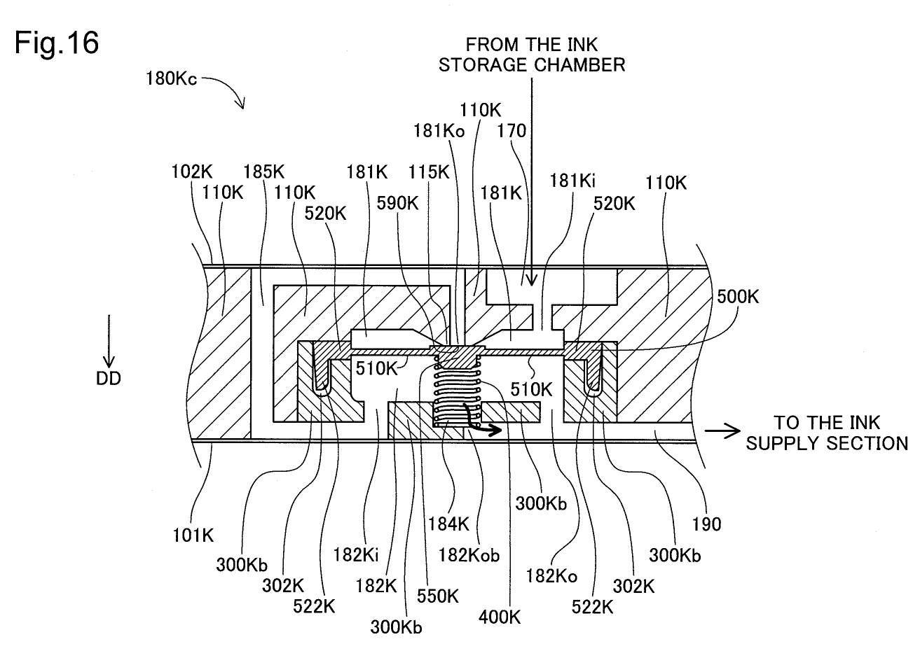

FIG. 16 is an explanatory drawing showing the constitution of the valve section 180Kc of the seventh embodiment. The difference with the valve section 180Kb of the seventh embodiment (see FIG. 15) is that the valve section 180Kc is provided so that the direction of the overall valve section is different. The direction of the overall valve section is changed so that the membrane valve 500K is roughly perpendicular to the gravitational force direction DD. With this embodiment, the downstream valve chamber 182K is arranged under the upstream valve chamber 181K. The flow path constitution of the valve section 180Kc is the same as the flow path of the valve section 180Kb of the seventh embodiment (note that with this embodiment, compared to the seventh embodiment, the valve upstream path 170 is larger). Therefore, the valve section 180Kc of this embodiment has the same various advantages as the valve section 180Kb of the seventh embodiment. For example, the outflow port 182Kob is arranged at the bottommost position of the gravitational force direction DD of the downstream valve chamber 182K, so it is possible to decrease the volume of ink remaining in the downstream valve chamber 182K without being consumed when the ink residual volume is decreased. In particular, the valve downstream path 190 is arranged under the outflow port 182Kob, so it is possible to easily supply the ink inside the downstream valve chamber 182K to the valve downstream path 190. Note that with the valve section 180Kc of this embodiment, the outflow port 182Ko may be omitted.

Note that the arrangement of elements other than the valve section 180Kc (correlating to the valve section 180) of the ink cartridge (FIG. 3) can be set as desired. For example, as with the fourth to sixth embodiments, it is also possible to arrange each element so that the membrane valve 500K is roughly parallel to the gravitational force direction DD.

### H. Eighth Embodiment

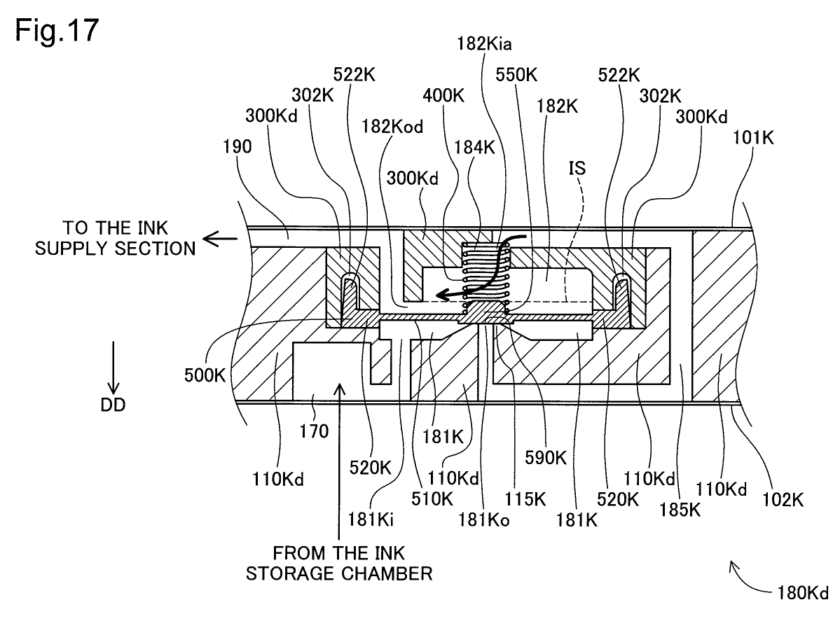

FIG. 17 is an explanatory drawing showing the constitution of the valve section 180Kd of the eighth embodiment. The main difference from the valve section 180Ka of the fifth embodiment (see FIG. 14) is that the valve section 180Kd is provided so that the overall valve section direction is different. The overall valve section direction is changed so that the membrane valve 500K is roughly perpendicular to the gravitational force direction DD. With this embodiment, the upstream valve chamber 181K is arranged under the downstream valve chamber 182K. The constitution of the flow path of the valve section 180Kd is approximately the same as the constitution of the flow path of the valve section 180Ka of FIG. 14. Note that with the valve section 180Kd of this embodiment, the outflow port 182Kod is arranged at the bottommost position of the gravitational force direction DD of the downstream valve chamber 182K. The shape of the part of the outflow port between the spring seat member 300Kd of this embodiment and the spring seat member 300Ka of the fifth embodiment is different. Also, with this embodiment, compared to the fifth embodiment, the valve upstream path 170 is bigger. The shape of the part of the valve upstream path 170 between the main body 110Kd of this embodiment and the main body 110K of the fifth embodiment is different.

The valve section 180Kd of this embodiment has the same constitution as the valve section 180Ka of the fifth embodiment. Therefore, the valve section 180Kd of this embodiment has the same various advantages as those of the valve section 180Ka of the fifth embodiment. For example, the outflow port 182Kod is arranged at the bottommost position of the downstream valve chamber 182K, so it is possible to decrease the volume of ink remaining in the downstream valve chamber 182K without being consumed when the ink residual volume is decreased. Note that with this embodiment, the valve downstream path 190 is arranged higher than the outflow port 182Kod. In this case as well, as will be described later, it is possible to decrease the volume of ink remaining in the downstream valve chamber 182K. With the first embodiment (see FIG. 1 and FIG. 3), the air from the air opening hole 130a is introduced according to the ink consumption, so air is not introduced from the supply port 120a. Therefore, with the downstream valve chamber 182K of this embodiment, when the ink is filled to higher than the outflow port 182Kod, with ink consumption, the ink inside the downstream valve chamber 182K can be supplied to the ink supply section 120 (FIG. 1 and FIG. 3) via the valve downstream path 190. In the drawing, the fluid surface IS shows the fluid surface of the same height as the top edge of the outflow port 182Kod. With this embodiment, at least the ink of the part that is higher than this fluid surface IS can be supplied to the valve downstream path 190 via the outflow port 182Kod.

Note that even with the other embodiments described above, similarly using the valve downstream path 190 including a part that is higher than the outflow port of the downstream valve chamber, it is possible to suitably supply ink to the ink supply section 120 from the downstream valve chamber.

Note that the arrangement of elements other than the valve section 180Kd (correlates to valve section 180) of the ink cartridge (FIG. 3) can be set as desired. For example as with the fourth to sixth embodiments, it is also possible to arrange each element such that the membrane valve 500K is roughly parallel to the gravitational force direction DD.

With the fourth to eighth embodiments described above, the upstream valve chamber 181K correlates to the “first chamber” in the claims, and the downstream valve chamber 182K correlates to the “second chamber.” Also, the relay flow path 185K correlates to the “communication flow path,” and the membrane valve 500K correlates to the “movable membrane.” Also, the spring accommodating chamber 184K correlates to the “concave portion that receives one end of the coil spring.” Also, the valve sections 180K, 180Ka, 180Kb, 180Kc, and 180Kd correlate to the “differential pressure regulating valve,” the ink storage chamber 140 correlates to the “liquid storage chamber,” the supply port 120a correlates to the “fluid supply port,” and the ink supply section 120 correlates to the “fluid supply section.”

### I. Modified Embodiments

Note that among the constitutional elements of each embodiment noted above, the elements other than elements claimed with the independent claims are additional elements, and can be omitted as appropriate. Also, the present invention is not limited to the embodiments and aspects noted above, but can be implemented in various modes in a scope that does not stray from the spirit of the invention, and for example the following variations are possible.

### First Modified Embodiment

With the embodiments noted above, the circuit board 13 and the sensing section 105 are provided, but it is also possible to not provide these.

Also, for the parts other than the constitution of the valve section, it is possible to suitably change the shape or position within a scope that does not stray from the spirit of the invention. For example, it is possible to change the position at which the ink supply port 120 or the lever 11 is provided, and to provide them on a surface different from those of these embodiments. It is also possible to change or to eliminate the shape of the lever 11. Furthermore, it is possible to make the outline of the cartridge a different shape, to change the shape or position of the ribs that partition the inside of the fluid container, or to constitute the main body divided into a plurality of parts.

### Second Modified Embodiment

With the embodiments noted above, one ink tank is constituted as one ink cartridge, but it is also possible to constitute a plurality of ink tanks as one ink cartridge.

### Third Modified Embodiment

The embodiments noted above adopt an inkjet type printer and ink cartridges, but it is also possible to adopt a liquid jetting device that sprays or blows out a liquid other than ink, and a liquid container that stores that liquid. This can also be diverted for use as various types of liquid consumption devices equipped with a liquid spraying head that blows out very small volumes of liquid drops. Note that liquid drops means a state with fluid being blown out from the aforementioned fluid jetting device, and includes grain shapes, teardrop shapes, and thread shapes after which a tail is drawn. Also, the liquid noted here is acceptable as long as it is a material that can be jetted by a liquid jetting device. For example, a state when the substance is in a liquid phase is acceptable, and includes not only fluid states such as high or low viscosity liquid states, sol, gel water, and other inorganic solvents, organic solvent, solutions, liquid resins, liquid metals (metal melt), or liquids as one state of a substance, but also items for which particles of a functional material consisting of solids such as pigments or metal particles or the like are dissolved, dispersed, or mixed in a solvent or the like. Also, representative examples of a liquid include the kind of inks described with the modes of the embodiments noted above, liquid crystal, or the like. Here, an ink means an item that contains various types of liquid compositions such as a typical water based ink and oil based ink as well as gel ink, hot melt ink and the like. As a specific example of a liquid jetting device, examples can be a liquid jetting device that sprays a liquid containing in a dispersed or dissolved mode a material such as an electrode material or coloring material or the like used in the manufacturing of liquid crystal displays, EL (electroluminescence) displays, surface light emitting displays, color filters, or the like, a liquid jetting device that sprays a biological organic substance for used in biochip manufacturing, or a liquid jetting device used as a precision pipette that sprays a liquid that will become a sample. Furthermore, it is also possible to adopt a liquid jetting device that sprays lubricating oil with a pinpoint on precision machines such as a clock, camera or the like, a liquid jetting device that sprays onto a substrate a transparent resin liquid such as an ultraviolet ray hardening resin or the like to form a micro hemispherical lens (optical lens) used for optical communication elements and the like, or a liquid jetting device that sprays an etching fluid such as acid, alkali or the like to etch a substrate or the like. Then, it is also possible to apply the present invention to any one type of these jetting devices and to a liquid container.

Also, the present invention is not limited to a liquid container placed on a carriage that goes back and forth in the liquid consuming device (on-carriage type liquid container), but can also be applied to a liquid container placed on a liquid storage unit that does not move (off-carriage type liquid container).

### Fourth Modified Embodiment

As the valve section constitution, these are not limited to the embodiments described above, and it is possible to adopt various constitutions. For example, it is also possible to replace the membrane valve of the first embodiment with the membrane valve of the fourth embodiment. It is also possible to replace the membrane valve of the fourth to eighth embodiments with the membrane valve of the first and second embodiments. It is also possible to suitably combine the constitutions of the embodiments described above. Also, with the embodiments described above, it is possible to omit part of the constitution. For example, with the first, second, and fourth to eighth embodiments, it is possible to omit the coil spring as in the case of the third embodiment. Also, with the first, second, and fourth to eighth embodiments, it is possible to adopt another elastic member such as rubber or the like instead of the coil spring. Also, the outflow port of the downstream valve chamber can be arranged at a position higher than the bottommost position of the downstream valve chamber.

### Fifth Modified Embodiment

With the embodiments described above, as shown in FIG. 3, the valve section (e.g. valve section 180) is provided between the ink storage chamber 140 and the ink supply section 120 (supply port 120a). Specifically, the valve section is linked to the ink storage chamber 140 via the upstream valve chamber inflow port (e.g. inflow port 181Ki in FIG. 11) (it is also possible to have other flow paths and chambers interposed between the valve section and the ink storage chamber 140). Then, the valve section is linked to the ink supply section 120 (supply port 120a) via the outflow port of the downstream valve chamber (e.g. the outflow port 182Ko in FIG. 11) (it is also possible to have other flow paths and chambers interposed between the valve section and the supply section 120). By adopting this kind of constitution, it is possible to reduce the volume of ink left remaining in the upstream valve chamber and the downstream valve chamber of the valve sections 180, 180K, 180Ka, 180Kb, 180Kc, and 180Kd.

Note that as the constitution of the ink path, this is not limited to the constitution shown in FIG. 3, and various other constitutions can be adopted. For example, it is also possible to use the valve sections 180, 180K, 180Ka, 180Kb, 180Kc, and 180Kd described above as the atmospheric valve for introducing the atmosphere. In specific terms, it is also possible to provide the valve section between the air opening hole 130a and the ink storage chamber 140. In this case, the valve section is linked to the air opening hole 130a via the outflow port of the upstream valve chamber (e.g. the outflow port 181Ki in FIG. 11) (it is also possible to have other flow paths and chambers interposed between the valve section and the air opening hole 130a). Then, the valve section is linked to the ink storage chamber 140 via the outflow port of the downstream valve chamber (e.g. the outflow port 182Ko in FIG. 11) (it is also possible to have other flow paths and chambers interposed between the valve section and the ink storage chamber 140). With consumption of the ink, the pressure (air pressure) in the downstream valve chamber is decreased. Then, when the absolute value of the difference between the pressure in the upstream valve chamber (atmospheric pressure) and the pressure of the downstream valve chamber (air pressure) (differential pressure) exceeds a specified pressure, the valve section opens, and air is introduced from the air opening hole 130a to the ink storage chamber 140. Also, this valve section suppresses the flow of ink from the ink storage chamber 140 to the air opening hole 130a. In this way, the valve section can also be a fluid (including at least one of liquid or gas) valve.

### Sixth Modified Embodiment

With the embodiments described above, as the material of the membrane valves 500, 500K, it is possible to use various elastic materials. As the elastic material, for example, it is possible to use silicon or an elastomer. Here, the more flexible the material of the membrane valve 500, 500K (in particular the membrane portion 510, 510K), the greater the deformation of the membrane portion 510, 510K with the same differential pressure. As a result, it is possible to make the valve sections 180, 180K, 180Ka, 180Kb, 180Kc, and 180Kd more compact. For example, it is possible to use a material for which the hardness level stipulated in Japanese JIS K 6523 is level 22 or lower. It is also possible to use a material of hardness level 4. If a flexible material is used in this way, it is possible to suitably open and close a valve using a small membrane valve. As this kind of flexible material, for example, it is possible to use the materials noted in Japanese Unexamined Patent Gazette 2000-978. Also, the entire membrane valve 500, 500K can be formed as a single unit, and it is also possible to form the membrane valve 500, 500K by adhering a plurality of parts. Even when the entire membrane valve 500, 500K is formed as a single unit, it is also possible to affix part of the membrane valve 500, 500K to other parts. For example, in FIG. 5 (A), the first installing portion 560 is affixed to the seal portion 520. Also, the specific gravity of the materials of the membrane valve 500, 500K can be heavier than the specific gravity of the ink, can be the same as the specific gravity of the ink, and can be lighter than the specific gravity of the ink.

Also, with the fourth to eighth embodiments, by fitting of the projecting part 522K of the membrane valve 500K with the groove 302K, it is possible to determine the position of the contact area 590 (in particular, the position of the direction perpendicular to the movement direction of the contact area 590K) with good precision. Therefore, it is also possible to omit the installing portions 560 and 570 (FIG. 5). In this case, the membrane valve 500K is a disk shaped member, and the outer periphery of the membrane valve 500 is formed by the seal portion 520K.

### Seventh Modified Embodiment

Above, various modes are described, but it is also possible to use the following kinds of modes.

Aspect 1. A differential pressure regulating valve comprising: a first chamber that has a first inflow port and a first outflow port, wherein a fluid introduced into the differential pressure regulating valve flows into the first chamber through the first inflow port; a second chamber that has a second inflow port and a second outflow port through which the fluid flows out from the second chamber; a communication flow path that links the first outflow port and the second inflow port; and a movable membrane provided between the first chamber and the second chamber, that can open and close the first outflow port by deforming according to a difference between a first pressure in the first chamber and a second pressure in the second chamber.

With this constitution, the fluid path goes through the serially connected first chamber and second chamber via the communication flow path, so it is possible to reduce the volume of fluid remaining in the first chamber and the second chamber.

Aspect 2. A differential pressure regulating valve according to Aspect 1, further comprising a coil spring arranged inside the second chamber, and urging the movable membrane toward the first outflow port.

With this constitution, it is possible to reduce the possibility of unintentional opening of the first outflow port.

Aspect 3. A differential pressure regulating valve according to Aspect 2, wherein an inner wall of the second chamber includes a concave portion that receives one end of the coil spring, and the second inflow port or the second outflow port is provided in the concave portion.

With this constitution, its possible to reduce the volume of fluid remaining in the concave portion.

Aspect 4. A differential pressure regulating valve according to Aspect 1, wherein the second outflow port is arranged at a bottommost position of the second chamber in the gravitational direction.

With this constitution, it is possible to reduce the volume of fluid remaining in the second chamber.

Aspect 5. A differential pressure regulating valve according to Aspect 1, wherein the movable membrane partitions the first chamber and the second chamber, and the first outflow port is arranged at a position facing opposite the movable membrane.

With this constitution, it is possible to easily realize opening and closing of the valve according to the differential pressure.

Aspect 6. A differential pressure regulating valve according to Aspect 5, wherein the movable membrane includes: a membrane portion that deforms according to the difference of the first pressure relative to the second pressure; and a movable seal that is fixed to the membrane portion that moves according to the deformation of the membrane portion to open and close the first outflow port, wherein when the difference of the first pressure relative to the second pressure exceeds a specified pressure, the membrane portion is deformed so that the movable seal separates from the first outflow port to open the first outflow port, and when the difference of the first pressure relative to the second pressure is the specified pressure or less, the membrane portion is deformed so that the movable seal presses on the first outflow port to close the first outflow port.

With this constitution, it is possible to suitably perform opening and closing of the valve.

Aspect 7. A liquid container that can be installed in a liquid jetting device, comprising: a liquid storage chamber that stores a liquid, a liquid supply section that supplies the liquid to the liquid jetting device, and a differential pressure regulating valve provided between the liquid storage chamber and the liquid supply section, wherein the differential pressure regulating valve comprises: a first chamber having a first inflow port and a first outflow port, wherein a liquid introduced into the differential pressure regulating valve flows into the first chamber through the first inflow port; a second chamber having a second inflow port and a second outflow port through which the liquid flows out from the second chamber; a communication flow path that links the first outflow port and the second inflow port; and a movable membrane provided between the first chamber and the second chamber, that can open and close the first outflow port, wherein the differential pressure regulating valve is linked to the liquid storage chamber via the first inflow port, and the differential pressure regulating valve is linked to the liquid supply section via the second outflow port.

Aspect 8. A liquid container according to Aspect 7, further comprising a coil spring arranged inside the second chamber, and energizing the movable membrane toward the first outflow port.

Aspect 9. A liquid container according to Aspect 8, wherein

an inner wall of the second chamber includes a concave portion that receives one end of the coil spring, and the second inflow port or the second outflow port is provided in the concave portion.

Aspect 10. A liquid container according to Aspect 7, wherein

the second outflow port is arranged at a bottommost position of the second chamber in the gravitational direction.

Aspect 11. A liquid container according to Aspect 7, wherein

the movable membrane partitions the first chamber and the second chamber, and the first outflow port is arranged at a position facing opposite the movable membrane.

Aspect 12. A liquid container according to Aspect 11, wherein

the movable membrane includes: a membrane portion that deforms according to the difference of the first pressure relative to the second pressure; and a movable seal that is fixed to the membrane portion that moves according to the deformation of the membrane portion to open and close the first outflow port, wherein when the difference of the first pressure relative to the second pressure exceeds a specified pressure, the membrane portion is deformed so that the movable seal separates from the first outflow port to open the first outflow port, and when the difference of the first pressure relative to the second pressure is the specified pressure or less, the membrane portion is deformed so that the movable seal presses on the first outflow port to close the first outflow port.

The various modes described above can also be suitably combined. Also, with each of the modes described above, it is also possible to omit part of the constitution.

### Eighth Modified Embodiment

Above, various modes are described, but it is also possible to use the following kinds of modes.

Aspect A1. A liquid container that can be installed in a liquid jetting device, comprising:

a main body having a liquid storage chamber for storing liquid, a liquid supply port for supplying the liquid to the liquid jetting device, a first flow path linked to the liquid storage chamber, and a second flow path linked to the liquid supply port, and

a membrane valve that is interposed between the first flow path and the second flow path, having a membrane portion,

the membrane valve having a first surface and a second surface on the side facing opposite the first surface,

the first surface receiving a first fluid pressure of the liquid in the first flow path,

the second surface receiving a second fluid pressure of the liquid in the second flow path,

the membrane portion of the membrane valve deforming to an open valve state which links the first flow path and the second flow path when the differential pressure of the first fluid pressure in relation to the second fluid pressure exceeds a specified pressure, and when the differential pressure is the specified pressure or less, deforming to a closed valve state for which the first flow path and the second flow path are not linked,

and the membrane valve is formed by an elastomer.

By working in this way, the membrane valve is formed using an elastomer, so the deformation of the membrane portion of the membrane valve in relation to pressure is stabilized, so the negative pressure generated by the membrane valve is stabilized.

Aspect A2. A liquid container in accordance with Aspect A1, wherein

in a state with the liquid container installed in the liquid jetting device, the membrane valve is arranged so that the membrane portion is roughly perpendicular in relation to the gravitational force direction.

By working in this way, the membrane portion is arranged so as to be roughly perpendicular to the gravitational force direction, so the variation due to gravitational force of the fluid pressure applied to the membrane portion is small. As a result, deformation of the membrane portion of the membrane valve in relation to fluid pressure is stabilized, so the negative pressure generated by the membrane valve is stabilized.

Aspect A3. A liquid container in accordance with Aspect A2, wherein

the first surface faces the upper side, and the second surfaces faces the lower side,

the membrane valve has a contact area and a pressure receiving area for receiving pressure on the first surface,

the main body further has a relay flow path for which one end is linked to the second flow path, in a closed valve state the other end is in contact with the contact area, and in an open valve state, the other end is linked to the first flow path, and

in a state with the liquid container installed in the liquid jetting device, the contact area is in a position lower than the pressure receiving area.

By working in this way, with the second flow path, the contact area is at a lower position than the pressure receiving area, so liquid is not left remaining in the second flow path, and it is possible to flow into the relay flow path without waste. As a result, it is possible to supply a liquid consumption device without waste of the liquid in the liquid container.

Aspect A4. A liquid container in accordance with Aspect A2, wherein

the first surface faces the upper side, and the second surfaces faces the lower side,

the liquid container further comprises

an elastic member that urges the membrane valve in the direction from the second surface facing the first surface,

and the specific gravity of the membrane valve is lower than the specific gravity of the liquid.

By working in this way, the membrane valve receives buoyancy force, so it is possible to make the elastic member compact.

Aspect A5. A liquid container in accordance with Aspect A4, wherein

the elastic member is an elastomer, and is formed as a single unit with the membrane valve.

By working in this way, it is possible to reduce the number of parts.

Aspect A6. A liquid container in accordance with Aspect A1, further comprising

an elastic member that presses the second surface of the membrane valve,

and the elastic member is formed using an elastomer.

By working in this way, it is possible to suppress holding of the liquid by the elastic member. As a result, it is possible to supply liquid in the liquid container to the liquid consumption device without waste.

Aspect A7. A liquid container in accordance with Aspect A6, wherein

the elastic member is formed as a single unit with the membrane valve.

By working in this way, it is possible to reduce the number of parts.

Aspect A8. For a liquid container that can be installed in a liquid jetting device, the liquid container having a liquid storage chamber for storing liquid, a liquid supply port for supplying the liquid to the liquid jetting device, a first flow path linked to the liquid storage chamber, and a second flow path linked to the liquid supply port, a membrane valve used interposed between the first flow path and the second flow path, the membrane valve comprising:

a first surface for receiving a first fluid pressure of the liquid in the first flow path,

a second surface on the side facing opposite the first surface for receiving a second fluid pressure of the liquid in the second flow path, and

a membrane portion that deforms to an open valve state with the first flow path and the second flow path linked when the differential pressure of the first fluid path in relation to the second flow path exceeds a specified pressure, and deforms to a closed valve state that makes a non-linked state of the first flow path and the second flow path when the differential pressure is the specified pressure or lower,

and the valve body is formed using an elastomer.

Aspect A9. A membrane valve in accordance with Aspect is A8, wherein

in a state with the liquid container installed in the liquid jetting device, the membrane valve is arranged so that the membrane portion is roughly perpendicular in relation to the gravitational force direction.

Aspect A10. A membrane valve in accordance with Aspect A9, wherein

the membrane valve has a contact area and a pressure receiving area for receiving pressure on the first surface,

the main body further has a relay flow path for which one end is linked to the second flow path, in a closed valve state the other end is in contact with the contact area, and in an open valve state, the other end is linked to the first flow path, and

in a state with the liquid container installed in the liquid jetting device, the contact area is in a position lower than the pressure receiving area.

Aspect A11. A membrane valve in accordance with Aspect A10, wherein

the specific gravity of the membrane valve is lower than the specific gravity of the liquid.

Aspect A12. A membrane valve in accordance with Aspect A11, further comprising

an elastic member that urges the valve body from the second surface toward the first surface,

and the elastic member is an elastomer, that is formed as a single unit with the valve body.

The various modes described above can be suitably combined. Also, with each mode described above, it is also possible to omit part of the constitution.

Above, embodiments and modified embodiments of the present invention are described, but the invention is not limited in any way by these embodiments and modified embodiments, and it is possible to implement various modes in a scope that does not stray from its spirit.

Although the present invention has been described and illustrated in detail, it is clearly understood that the same is by way of illustration and example only and is not to be taken by way of limitation, the spirit and scope of the present invention being limited only by the terms of the appended claims.

1. A differential pressure regulating valve comprising:
a first chamber that has a first inflow port and a first outflow port, wherein a fluid introduced into the differential pressure regulating valve flows into the first chamber through the first inflow port;
a second chamber that has a second inflow port and a second outflow port through which the fluid flows out from the second chamber;
a communication flow path that links the first outflow port and the second inflow port; and
a movable membrane provided between the first chamber and the second chamber, that can open and close the first outflow port by deforming according to a difference between a first pressure in the first chamber and a second pressure in the second chamber.

2. A differential pressure regulating valve according to claim 1, further comprising
a coil spring arranged inside the second chamber, and urging the movable membrane toward the first outflow port.

3. A differential pressure regulating valve according to claim 2, wherein
an inner wall of the second chamber includes a concave portion that receives one end of the coil spring, and
the second inflow port or the second outflow port is provided in the concave portion.

4. A differential pressure regulating valve according to claim 1, wherein
the second outflow port is arranged at a bottommost position of the second chamber in the gravitational direction.

5. A differential pressure regulating valve according to claim 1, wherein
the movable membrane partitions the first chamber and the second chamber, and
the first outflow port is arranged at a position facing opposite the movable membrane.

6. A differential pressure regulating valve according to claim 5, wherein
the movable membrane includes:
a membrane portion that deforms according to the difference of the first pressure relative to the second pressure; and
a movable seal that is fixed to the membrane portion that moves according to the deformation of the membrane portion to open and close the first outflow port, wherein
when the difference of the first pressure relative to the second pressure exceeds a specified pressure, the membrane portion is deformed so that the movable seal separates from the first outflow port to open the first outflow port, and
when the difference of the first pressure relative to the second pressure is the specified pressure or less, the membrane portion is deformed so that the movable seal presses on the first outflow port to close the first outflow port.

7. A liquid container that can be installed in a liquid jetting device, comprising:
a liquid storage chamber that stores a liquid,
a liquid supply section that supplies the liquid to the liquid jetting device, and
a differential pressure regulating valve provided between the liquid storage chamber and the liquid supply section, wherein
the differential pressure regulating valve comprises:
a first chamber having a first inflow port and a first outflow port, wherein a liquid introduced into the differential pressure regulating valve flows into the first chamber through the first inflow port;
a second chamber having a second inflow port and a second outflow port through which the liquid flows out from the second chamber;
a communication flow path that links the first outflow port and the second inflow port; and
a movable membrane provided between the first chamber and the second chamber, that can open and close the first outflow port, wherein
the differential pressure regulating valve is linked to the liquid storage chamber via the first inflow port, and
the differential pressure regulating valve is linked to the liquid supply section via the second outflow port.

8. A liquid container according to claim 7, further comprising
a coil spring arranged inside the second chamber, and urging the movable membrane toward the first outflow port.

9. A liquid container according to claim 8, wherein
an inner wall of the second chamber includes a concave portion that receives one end of the coil spring, and
the second inflow port or the second outflow port is provided in the concave portion.

10. A liquid container according to claim 7, wherein
the second outflow port is arranged at a bottommost position of the second chamber in the gravitational direction.

11. A liquid container according to claim 7, wherein
the movable membrane partitions the first chamber and the second chamber, and
the first outflow port is arranged at a position facing opposite the movable membrane.

12. A liquid container according to claim 11, wherein
the movable membrane includes:
a membrane portion that deforms according to the difference of the first pressure relative to the second pressure; and
a movable seal that is fixed to the membrane portion that moves according to the deformation of the membrane portion to open and close the first outflow port, wherein
when the difference of the first pressure relative to the second pressure exceeds a specified pressure, the membrane portion is deformed so that the movable seal separates from the first outflow port to open the first outflow port, and
when the difference of the first pressure relative to the second pressure is the specified pressure or less, the membrane portion is deformed so that the movable seal presses on the first outflow port to close the first outflow port.
